(19) United States
(12) Patent Application Publication
(10) Pub. No.: US 2006/0143960 A1
(43) Pub. Date: Jul. 6, 2006

(54) Protective device for a portable sign or sign frame

(76) Inventor: D. Maria Gnas, Lexington, KY (US)

Correspondence Address: KING & SCHICKLI, PLLC, 247 NORTH BROADWAY, LEXINGTON, KY, 40507, US

(21) Appl. No.: 11/327,259

(22) Filed: Jan. 6, 2006

Related U.S. Application Data
(60) Provisional application No. 60/641,685, filed on Jan. 6, 2005.

(51) Int. Cl. G09F 15/00

(52) U.S. Cl. 40/607.01

(57) ABSTRACT

A protective device for a portable sign or sign frame includes a leg sleeve having a bore and a cover received over the sleeve. In addition a protective sign kit is provided including first and second leg sleeves, covers for the sleeves and a corner protector for the sign.

This application claims the benefit of U.S. Provisional Patent Application Ser. No. 60/641,685 filed on 6 Jan. 2005.

### TECHNICAL FIELD

The present invention relates generally to the portable signage field and, more particularly, to a protective device for a portable sign or sign frame.

### BACKGROUND OF THE INVENTION

Portable signs or sign frames are well known in the art. They have been utilized for years to promote businesses, charities, social events and other enterprises. Many individuals must handle and transport portable signage on a day-to-day basis. For example, real estate agents must transport such signage to new properties going up for sale and remove such signage from sold properties.

Many portable signs such as real estate signs are made from relatively heavy metal so as to be durable and provide a long service life. Of course, such signs also include pointed legs so that they may be anchored in the ground for display. Typically they also include relatively pointed or sharp corners.

When such signs are transported in a moving vehicle, they often shift or slide as the vehicle negotiates turns or brakes hard to a stop. In many such instances, the pointed legs or sharp corners come into contact with the interior of the vehicle causing unsightly damage. Further, it is not unusual for the legs of these signs to be muddy or dirty when they are removed from the lawn. Accordingly, it is clear that a need is identified for a protective device which will reduce the risk of or prevent damage to a vehicle from the sign during transport. Advantageously, such a device should also be adapted to prevent mud and dirt from the legs of a sign from being spread over the interior of the vehicle.

### SUMMARY OF THE INVENTION

A protective device is provided for a portable sign or sign frame. That device comprises a leg sleeve including a bore and a cover received over the sleeve. The leg sleeve is constructed from a resilient material. The cover includes a tie that is utilized to secure the cover in position. The cover is made from a fabric and includes indicia. That indicia may be selected from a group consisting of an individual's name, a company name, a trademark, a logo and combinations thereof. In addition, the protective device may include a removable end cap that is received in the bore of the leg sleeve.

In accordance with an additional aspect of the present invention a protective kit is provided for a portable sign or sign frame. The protective kit comprises a first leg sleeve and a second leg sleeve. First and second fabric covers are provided for the first and second leg sleeves. The first and second covers include indicia on an exposed face thereof. That indicia is selected from a group consisting of an individual's name, a company name, a trademark, a logo and combinations thereof.

Further describing the invention, a first tie is connected to the first fabric cover and a second tie is connected to the second fabric cover. These ties may be used to secure the covers in position over the leg sleeves by engaging a portion of the sign being covered.

The kit further includes a first removable end cap for closing a first bore or lumen of the first leg sleeve at a first end and a second removable end cap for closing a second bore or lumen of the second leg sleeve at a second end. Further the kit includes a first corner protector including a first channel for receiving and holding a first corner of the sign or sign frame and a second corner protector including a second channel for receiving and holding a second corner of the sign or sign frame. The first and second corner protectors may be constructed from a resilient material. In addition the first and second corner protectors may be substantially L-shaped. In an alternative embodiment of the protective kit, a substantially C-shaped corner protector is provided. The C-shaped corner protector has a channel for receiving and holding first and second corners of the portable sign or sign frame.

In accordance with still another aspect of the present invention a method is provided. That method comprises the steps of providing at least one leg sleeve that may be selectively positioned over a leg of a real estate sign or real estate sign frame, promoting a real estate business by displaying promotional indicia on the at least one leg sleeve and selling the at least one leg sleeve to a real estate agent. The method may further include the step of providing at least one corner protector that may be selectively positioned over at least one corner of a real estate sign or real estate sign frame.

In the following description there is shown and described several embodiments of this invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of this specification, illustrate several aspects of the present invention, and together with the description serve to explain certain principles of the invention. In the drawings:

FIG. 1 is an exploded perspective view of the protective kit of the present invention;

FIG. 2 is a perspective view showing the protective kit secured to a metal real estate sign or sign frame;

FIG. 3 is a detailed cross-sectional view showing the protective device secured around the leg of a sign or sign frame;

FIG. 4 is a detailed cross-sectional view along line 4-4 of FIGS. 2 and 5 showing the corner protector of the present invention secured to a top edge of the sign or sign frame;

FIG. 5 is a detailed perspective view showing an alternative embodiment of the corner protector;

FIG. 6 is an exploded elevational view of an alternative embodiment; and

FIG. 7 is a side elevational view of the alternative embodiment also illustrated in FIG. 6.

Reference will now be made in detail to exemplary embodiments of the present invention as illustrated in the accompanying drawings.

### DETAILED DESCRIPTION OF THE INVENTION

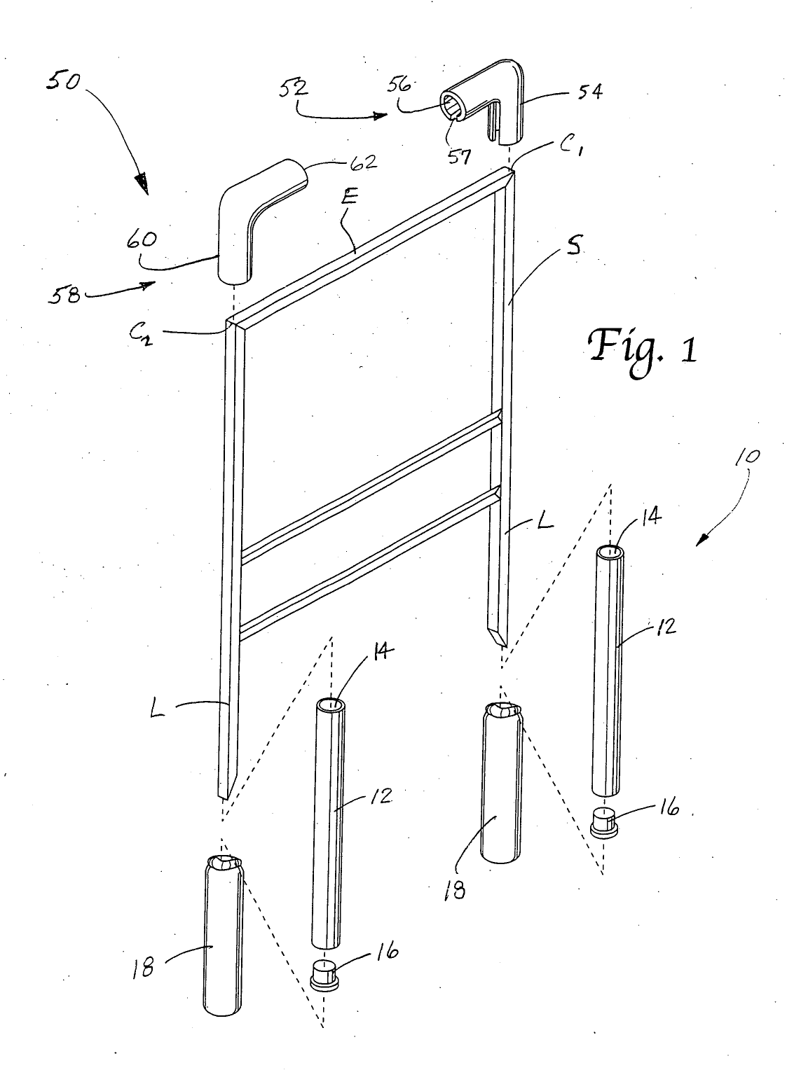

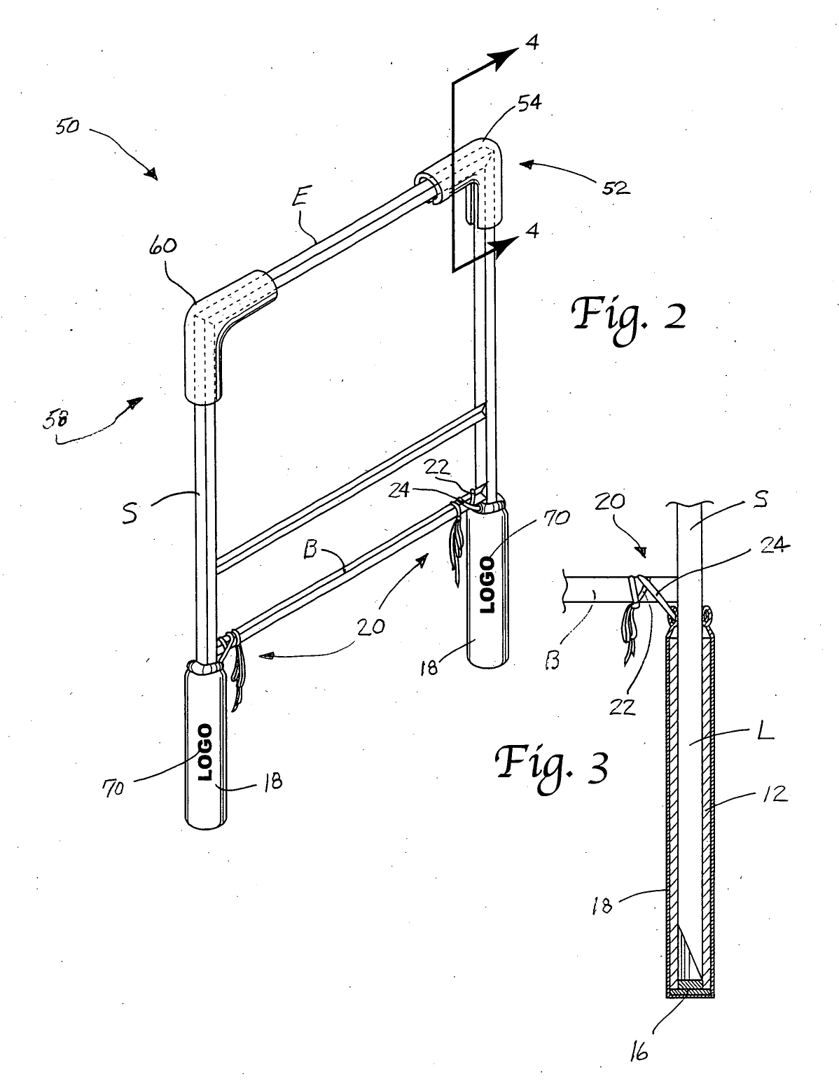

Reference is now made to FIG. 1 showing two of the protective devices 10 of the present invention for a portable sign or sign frame. In the most preferred embodiment, the protective device 10 comprises a body in the form of a sleeve 12 having a bore or interior lumen 14. Preferably the sleeve 12 is formed from a resilient material such as a plastic or rubber which may or may not be reinforced with fiberglass or other appropriate reinforcing material. Such a material may be easily pushed over the leg L of a sign or sign frame S (see also FIGS. 2 and 3) while providing a relatively soft and forgiving surface to protect, for example, the interior of a vehicle from damage from the leg L.

In the illustrated embodiment the sleeve 12 receives a removable end cap 16 at one end. The end cap 16 forms a blind bore with the lumen 14 of the sleeve 12. Advantageously, the end cap 16 prevents the pointed end of the leg L of the sign or sign frame S from protruding from the end of the sleeve 12. Further, the blind bore functions to hold any dirt and debris remaining on the leg L in the lumen 14 of the sleeve 12 and away from the interior of the transporting vehicle. Of course, the end cap 16 may be removed from the sleeve 12 and water run through the lumen 14 in order to clean the bore when desired. This is a particularly advantageous feature when the bore of the sleeve is caked with dried on mud or the like.

As further illustrated, the protective device 10 may also include an optional fabric cover 18. The fabric cover 18 may be decorative and incorporate a design or interesting color. Preferably, the fabric for the cover 18 is selected from a group of materials consisting of nylon, rayon, polyester and mixtures thereof. It should be appreciated, however, that substantially any appropriate fabric could be utilized.

As further illustrated the cover 18 includes a lace or tie, generally designated by reference numeral 20. The lace 20 includes a first end 22 and a second end 24. In use, the removable end cap 16 is secured in the end of the lumen 14 of the sleeve 12 by plug, threads or any appropriate means. The sleeve 12 is then positioned in the cover 18, capped end first. The sleeve 12 is then positioned over the leg L of the sign or sign frame S by pushing the open end of the sleeve 12 over the leg. The sleeve 12 is fully seated on the leg L when the end of the leg engages the end cap 16.

In many instances, the lumen 14 of the sleeve 12 is sized to receive the leg L but provide sufficient frictional engagement with the leg and through the resilient memory of the material to maintain the sleeve 12 in position on the leg L. In other instances, it may be desirable to use the lace 20 to maintain the sleeve 12 on the leg L. This may be done by tying the lace ends 22, 24 over a reinforcing bar B of the sign or sign frame S as best illustrated in FIG. 3.

In accordance with yet another aspect of the present invention, a protective kit 50 is provided for a portable sign or sign frame S. The kit 50 comprises at least two protective devices 10 of the type described above. In addition, the kit 50 includes a first corner protector 52. The first corner protector 52 includes a substantially L-shaped body 54 of resilient material (e.g. plastic, rubber, fiberglass reinforced plastic or rubber) including a first channel 56. The first channel 56 is sized and shaped to be received over a first corner C₁ of the sign or sign frame S but still provide frictional engagement through the resilient memory of the material so as to positively secure the first cover protector 52 in position.

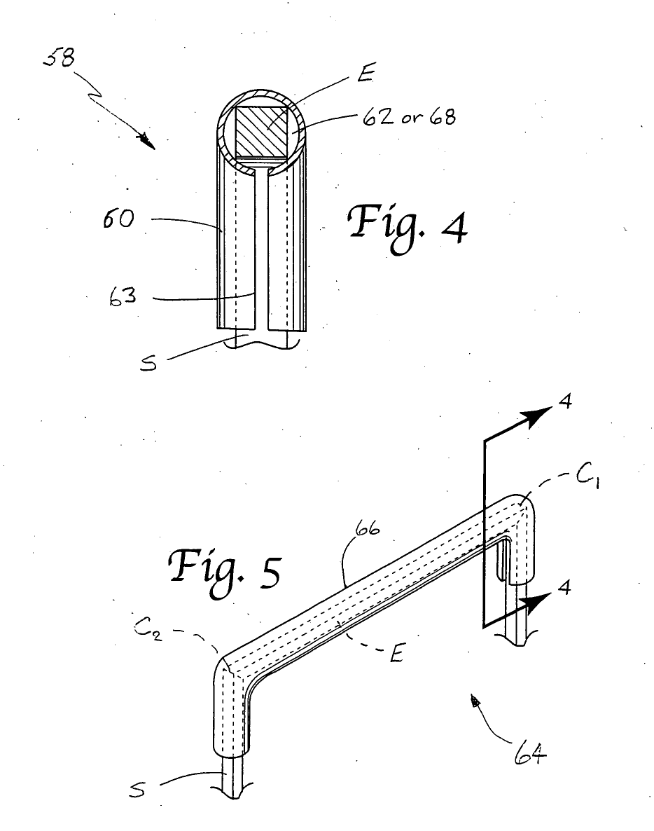

In the illustrated embodiment, the corner protector 52 is a split sleeve and the channel 56 is a lumen of that sleeve. The protector 52 is inserted over the corner C₁ by spreading the split or seam 57 and pushing the protector down over the corner C₁ so that the protector is seated with the corner C₁ received in the channel 56 (see FIG. 4).

The kit 50 also includes a second corner protector 58 substantially identical to the first corner protector 52 and including an L-shaped body 60, a second channel 62 and a seam 63. The second channel 62 of the second corner protector 58 is sized and shaped to be received over a second corner C₂ of the sign or sign frame S while providing positive engagement to hold the protector 58 in position.

In an alternative embodiment illustrated in FIG. 5, the kit 50 includes a corner protector 64 having a substantially C-shaped body 66 (again, made of plastic, rubber, fiberglass reinforced plastic or rubber). The C-shaped body 66 includes a substantially C-shaped channel 68 sized and shaped to fit over the first and second corners C₁, C₂ and top edge E of a sign or sign frame S while being positively held in position through resilient memory engagement of the C-shaped body 66 with the sign or sign frame S.

In accordance with another aspect of the present invention, the fabric cover 18 may include indicia 70 on an exposed face thereof. The indicia 70 may consist of an individual's name such as the name of the real estate agent to which the protective device 10 belongs. Alternatively, the cover 18 may include promotional indicia such as a company name, trademark, logo or a combination thereof. In this way the device 10 or kit 50 of the present invention may be utilized to promote a business such as a real estate business.

The foregoing description of the invention has been presented for purposes of illustration and description. It is not intended to be exhaustive or to limit the invention to the precise form disclosed. Obvious modifications or variations are possible in light of the above teachings.

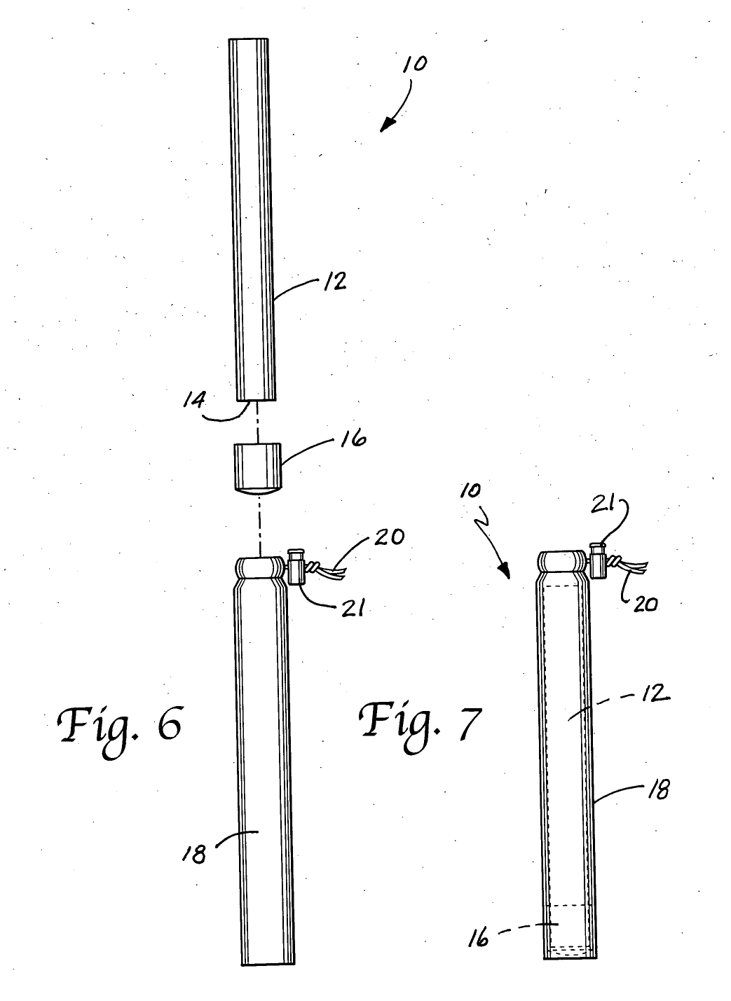

For example, an alternative embodiment of the protective device 10 is illustrated in FIGS. 6 and 7. The device 10 includes a sleeve 12 with a bore or lumen 14 which is identical to the sleeve described above with respect to the FIG. 1 embodiment. A removable end cap 16 is provided at one end of the sleeve 12 to close the lumen 14 and form a blind bore. This end cap 16 friction fits around the sleeve 12. A fabric cover 18 is received over the sleeve 12 and end cap 16. The cover 18 is secured in place over the sleeve 12 by the lace or tie 20 and cooperating spring clip fastener 21 that functions as a cinch.

All such modifications and variations are within the scope of the invention as determined by the appended claims when interpreted in accordance with the breadth to which they are fairly, legally and equitably entitled.

What is claimed:

1. A protective device for a portable sign or sign frame, comprising:
a leg sleeve including a bore; and
a cover received over said sleeve.

2. The device of claim 1, wherein said leg sleeve is constructed from a resilient material.

3. The device of claim 2, wherein a tie is connected to said cover.

4. The device of claim 3, further including a removable end cap closing one end of said bore of said leg sleeve.

5. The device of claim 1, wherein said cover is made from a fabric.

6. The device of claim 5, wherein said fabric carries indicia.

7. The device of claim 6, wherein said indicia is selected from a group consisting of an individual's name, a company name, a trademark, a logo and combinations thereof.

8. A protective kit for a portable sign or sign frame, comprising:
a first leg sleeve; and
a second leg sleeve.

9. The protective kit of claim 8 further including a first fabric cover for said first leg sleeve and a second fabric cover for said second leg sleeve.

10. The protective kit of claim 9, wherein at least one of said first and second covers includes indicia on an exposed face thereof.

11. The protective kit of claim 10, wherein said indicia is selected from a group consisting of an individual's name, a company name, a trademark, a logo and combinations thereof.

12. The protective kit of claim 9, further including a first tie connected to said first fabric cover and a second tie connected to said second fabric cover.

13. The protective kit of claim 8, further including a first removable end cap for closing a first lumen of said first leg sleeve at a first end and a second removable end cap for closing a second lumen of said second leg sleeve at a second end.

14. The protective kit of claim 8, further including a first corner protector including a first channel for receiving and holding a first corner of said portable sign or sign frame and a second corner protector including a second channel for receiving and holding a second corner of said portable sign or sign frame.

15. The protective kit of claim 14, wherein said first and second corner protectors are constructed from a resilient material.

16. The protective kit of claim 14, wherein said first and second corners protectors are both substantially L-shaped.

17. The protective kit of claim 8, further including a substantially C-shaped corner protector having a channel for receiving and holding first and second corners of said portable sign or sign frame.

18. A method, comprising:
providing at least one leg sleeve that may be selectively positioned over a leg of a real estate sign or real estate sign frame;
promoting a real estate business by displaying promotional indicia on said at least one leg sleeve; and
selling said at least one leg sleeve to a real estate agent.

19. The method of claim 18, further including providing at least one corner protector that may be selectively positioned over at least one corner of a real estate sign or real estate sign frame with said at least one leg sleeve.
